(19) United States
(12) Patent Application Publication
(10) Pub. No.: US 2013/0179959 A1
(43) Pub. Date: Jul. 11, 2013

(54) Zero Token

(71) Applicants: Dustin L. Green, Redmond, WA (US); Rajeev Nagar, Sammamish, WA (US); Neal R. Christiansen, Bellevue, WA (US)

(72) Inventors: Dustin L. Green, Redmond, WA (US); Rajeev Nagar, Sammamish, WA (US); Neal R. Christiansen, Bellevue, WA (US)

(73) Assignee: MICROSOFT CORPORATION, Redmond, WA (US)

(21) Appl. No.: 13/343,718

(22) Filed: Jan. 5, 2012

(51) Int. Cl. H04L 9/32

(52) U.S. Cl. 726/9

(57) ABSTRACT

Aspects of the subject matter described herein relate to a zero token. In aspects, a zero token may be used to represent one or more zeroes in an offload write command. A component receiving an offload write command with the zero token is free to write the zeroes in a variety of ways including, for example, changing data structures the component uses to represent the zeroes, issuing another command that writes zeroes, writing physical zeroes, and so forth. A component receiving an offload write command with the zero token does not need to verify that the zero token was obtained from a successful offload read or that the zero token is still valid. In response to an offload read request, a component may provide the zero token to represent all or a portion of the data associated with the offload read request.

### BACKGROUND

One mechanism for transferring data is to read the data from a file of a source location into main memory and write the data from the main memory to a destination location. While in some environments, this may work acceptably for relatively little data, as the data increases, the time it takes to read the data and transfer the data to another location increases. In addition, if the data is accessed over a network, the network may impose additional delays in transferring the data from the source location to the destination location. Furthermore, security issues combined with the complexity of storage arrangements may complicate data transfer.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to a zero token. In aspects, a zero token may be used to represent one or more zeroes in an offload write command. A component receiving an offload write command with the zero token is free to write the zeroes in a variety of ways including, for example, changing data structures the component uses to represent the zeroes, issuing another command that writes zeroes, writing physical zeroes, and so forth. A component receiving an offload write command with the zero token does not need to verify that the zero token was obtained from a successful offload read or that the zero token is still valid. In response to an offload read request, a component may provide the zero token to represent all or a portion of the data associated with the offload read request.

### BRIEF DESCRIPTION OF THE DRAWINGS

FIG. 1 is a block diagram representing an exemplary general-purpose computing environment into which aspects of the subject matter described herein may be incorporated;

FIGS. 2-3 are block diagrams that represent exemplary arrangements of components of systems in which aspects of the subject matter described herein may operate;

FIG. 4 is a flow diagram that generally represents exemplary actions that may occur in conjunction with an offload read request in accordance with aspects of the subject matter described herein; and

FIG. 5 is a flow diagram that generally represents exemplary actions that may occur in conjunction with an offload write request in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or, action. In particular, in the claims a reference to an item generally means at least one such item is present and a reference to an action means at least one instance of the action is performed.

Sometimes herein the terms “first”, “second”, “third” and so forth may be used. Without additional context, the use of these terms in the claims is not intended to imply an ordering but is rather used for identification purposes. For example, the phrase “first version” and “second version” does not necessarily mean that the first version is the very first version or was created before the second version or even that the first version is requested or operated on before the second versions. Rather, these phrases are used to identify different versions.

Headings are for convenience only; information on a given topic may be found outside the section whose heading indicates that topic.

Other definitions, explicit and implicit, may be included below.

### Exemplary Operating Environment

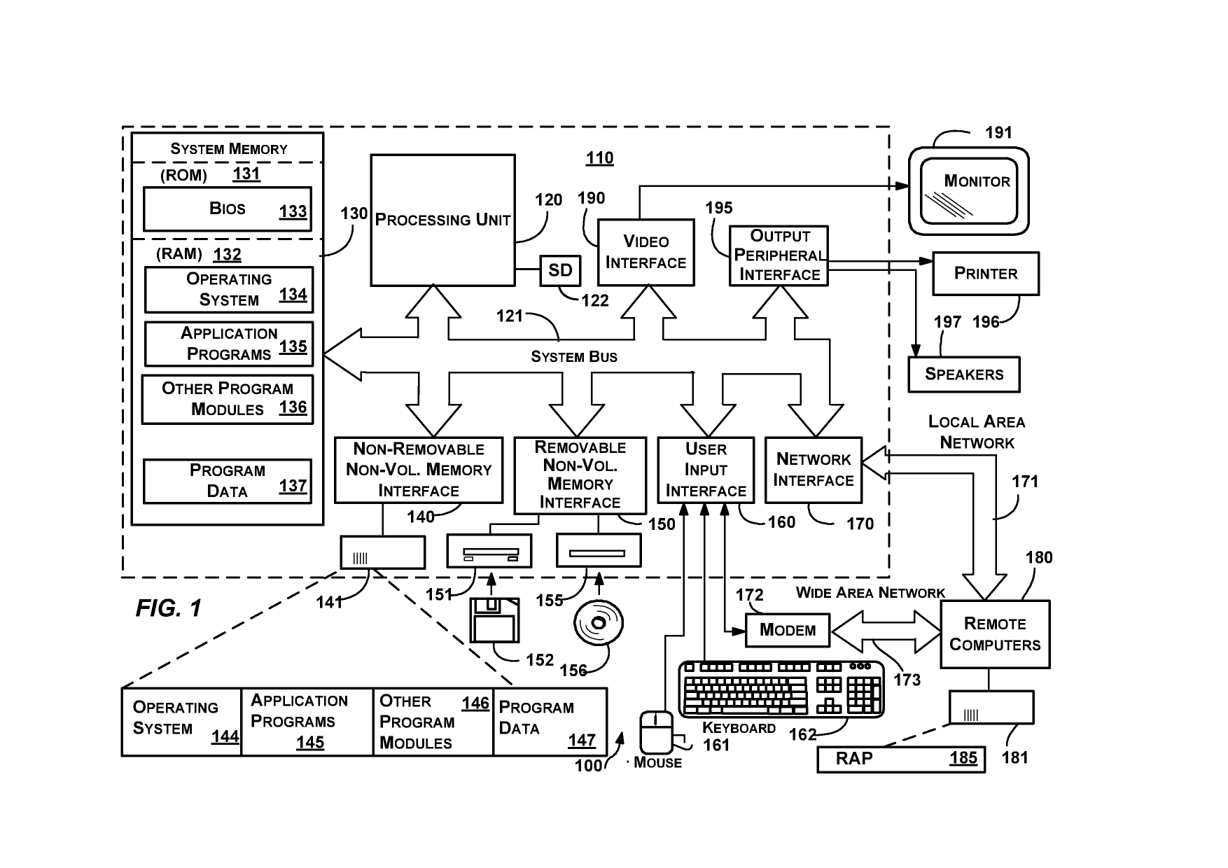

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The processing unit 120 may be connected to a hardware security device 122. The security device 122 may store and be able to generate cryptographic keys that may be used to secure various aspects of the computer 110. In one embodiment, the security device 122 may comprise a Trusted Platform Module (TPM) chip, TPM Security Device, or the like.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, solid state storage, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards and other solid state storage devices, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable non-volatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Offload Reads and Writes

As mentioned previously, some traditional data transfer operations may not be efficient or even work in today's storage environments.

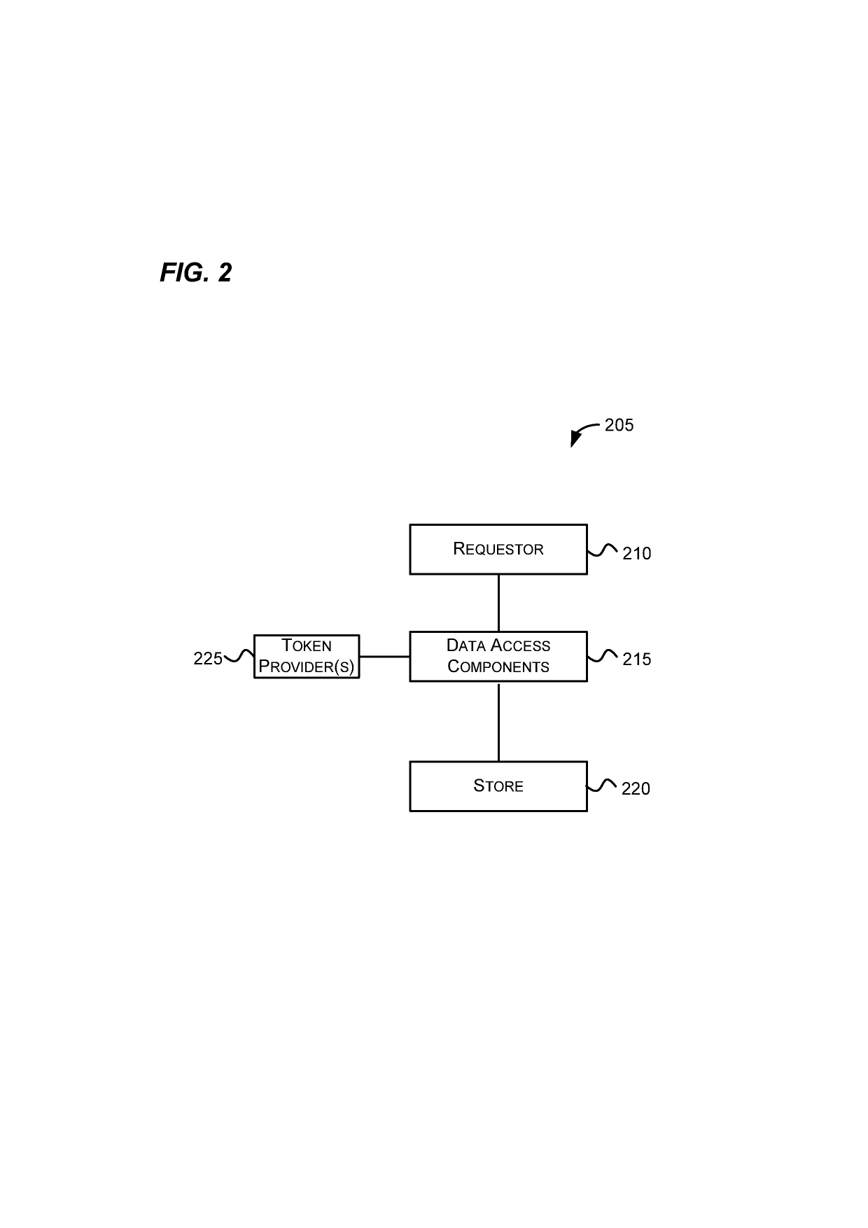

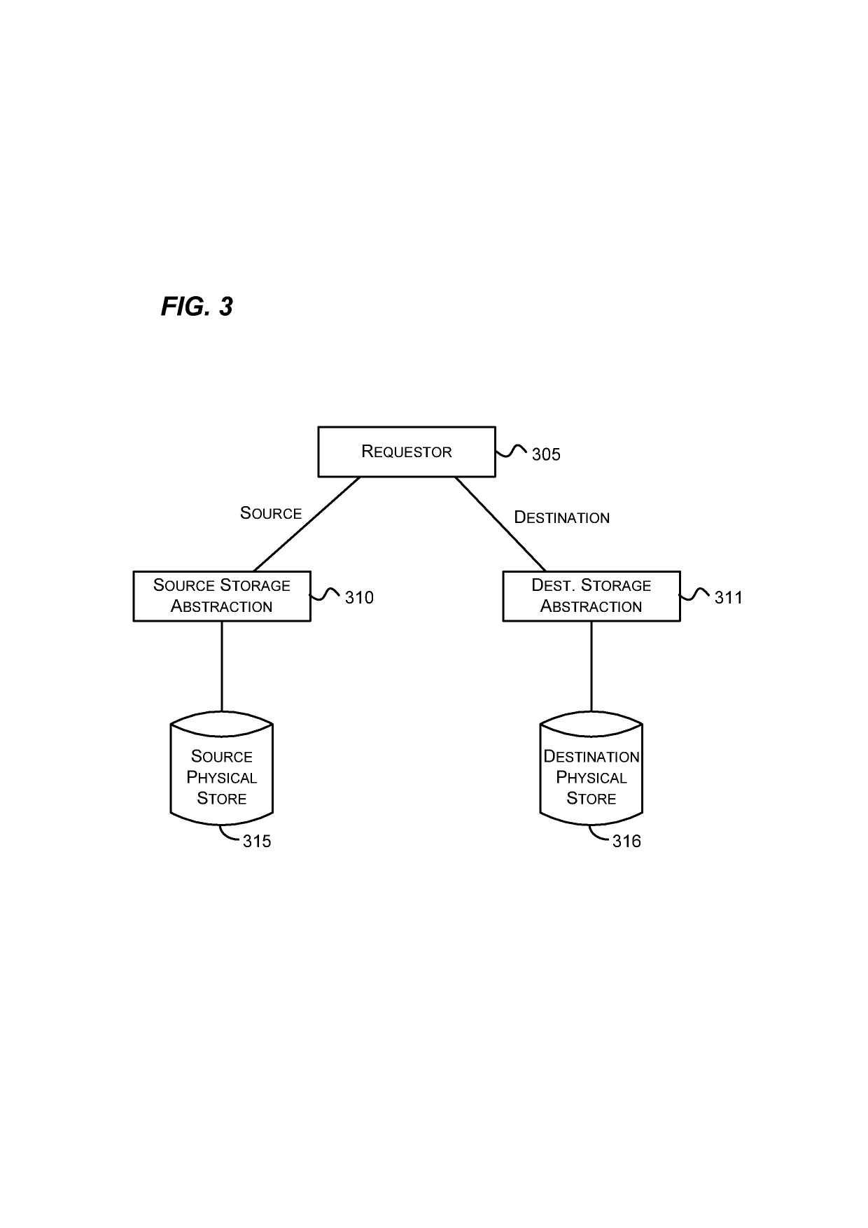

FIGS. 2-3 are block diagrams that represent exemplary arrangements of components of systems in which aspects of the subject matter described herein may operate. The components illustrated in FIGS. 2-3 are exemplary and are not meant to be all-inclusive of components that may be needed or included. In other embodiments, the components and/or functions described in conjunction with FIGS. 2-3 may be included in other components (shown or not shown) or placed in subcomponents without departing from the spirit or scope of aspects of the subject matter described herein. In some embodiments, the components and/or functions described in conjunction with FIGS. 2-3 may be distributed across multiple devices.

Turning to FIG. 2, the system 205 may include a requestor 210, data access components 215, token provider(s) 225, a store 220, and other components (not shown). The system 205 may be implemented via one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like.

Where the system 205 comprises a single device, an exemplary device that may be configured to act as the system 205 comprises the computer 110 of FIG. 1. Where the system 205 comprises multiple devices, one or more of the multiple devices may comprise the computer 110 of FIG. 1 where the multiple devices may be configured similarly or differently.

The data access components 215 may be used to transmit data to and from the store 220. The data access components 215 may include, for example, one or more of: I/O managers, filters, drivers, file server components, components on a storage area network (SAN) or other storage device, and other components (not shown). As used herein, a SAN may be implemented, for example, as a device that exposes logical storage targets, as a communication network that includes such devices, or the like.

In one embodiment, a data access component may comprise any component that is given an opportunity to examine I/O between the requestor 210 and the store 220 and that is capable of changing, completing, or failing the I/O or performing other or no actions based thereon. For example, where the system 205 resides on a single device, the data access components 215 may include any object in an I/O stack between the requestor 210 and the store 220. Where the system 205 is implemented by multiple devices, the data access components 215 may include components on a device that hosts the requestor 210, components on a device that provides access to the store 220, and/or components on other devices and the like. In another embodiment, the data access components 215 may include any components (e.g., such as a service, database, or the like) used by a component through which the I/O passes even if the data does not flow through the used components.

As used herein, the term component is to be read to include hardware such as all or a portion of a device, a collection of one or more software modules or portions thereof, some combination of one or more software modules or portions thereof and one or more devices or portions thereof, and the like. A component may include or be represented by code.

In one embodiment, the store 220 is any storage media capable of storing data. The store 220 may include volatile memory (e.g., a cache) and non-volatile memory (e.g., a persistent storage). The term data is to be read broadly to include anything that may be represented by one or more computer storage elements. Logically, data may be represented as a series of 1's and 0's in volatile or non-volatile memory. In computers that have a non-binary storage medium, data may be represented according to the capabilities of the storage medium. Data may be organized into different types of data structures including simple data types such as numbers, letters, and the like, hierarchical, linked, or other related data types, data structures that include multiple other data structures or simple data types, and the like. Some examples of data include information, program code, program state, program data, commands, other data, or the like.

The store 220 may comprise hard disk storage, solid state, or other non-volatile storage, volatile memory such as RAM, cache, or other volatile storage, some combination of the above, and the like and may be distributed across multiple devices (e.g., multiple SANs, multiple file servers, a combination of heterogeneous devices, and the like). The devices used to implement the store 220 may be located physically together (e.g., on a single device, at a datacenter, or the like) or distributed geographically. The store 220 may be arranged in a tiered storage arrangement or a non-tiered storage arrangement. The store 220 may be external, internal, or include components that are both internal and external to one or more devices that implement the system 205. The store 220 may be formatted (e.g., with a file system) or non-formatted (e.g., raw).

In another embodiment, the store 220 may be implemented as a storage abstraction rather than as direct physical storage. A storage abstraction may include, for example, a file, volume, disk, virtual disk, logical unit, data stream, alternate data stream, metadata stream, or the like. For example, the store 220 may be implemented by a server having multiple physical storage devices. In this example, the server may present an interface that allows a data access component to access data of a store that is implemented using one or more of the physical storage devices or portions thereof of the server.

The level of abstraction may be repeated to any arbitrary depth. For example, the server providing a storage abstraction to the data access components 215 may also rely on a storage abstraction to access data.

In another embodiment, the store 220 may include a component that provides a view into data that may be persisted in non-volatile storage or not persisted in non-volatile storage.

One or more of the data access components 215 may reside on an apparatus that hosts the requestor 210 while one or more other of the data access components 215 may reside on an apparatus that hosts or provides access to the store 220. For example, if the requestor 210 is an application that executes on a personal computer, one or more of the data access components 215 may reside in an operating system hosted on the personal computer. As another example, if the store 220 is implemented by a storage area network (SAN), one or more of the data access components 215 may implement a storage operating system that manages and/or provides access to the store 220. When the requestor 210 and the store 220 are hosted in a single apparatus, all or many of the data access components 215 may also reside on the apparatus.

An offload read allows a requestor to obtain a token that represents immutable data. Using this token, the requestor or another entity may request an offload write. An offload write allows a requestor to cause an offload provider to write some or all of the data represented by the token.

An offload provider is an entity (possibly including multiple components spread across multiple devices) that provides access to data associated with a store—source or destination. Access as used herein may include reading data, writing data, deleting data, updating data, a combination including two or more of the above, and the like. Logically, an off load provider is capable of performing an offload read or write. Physically, an offload provider may include one or more of the data access components 215 and may also include the token provider 225.

An offload provider may transfer data from a source store, write data to a destination store, and maintain data to be provided upon receipt of a token associated with the data. In some implementations, an offload provider may indicate that an offload write command is completed after the data has been logically written to the destination store. In addition, an offload provider may indicate that an offload write command is completed but defer physically writing data associated with the offload write until convenient.

To initiate an offload read of data of the store 220, the requestor 210 may send a request to obtain a token representing the data using a predefined command (e.g., via an API). In response, one or more of the data access components 215 may respond to the requestor 210 by providing one or more tokens that represents the data or a subset thereof. A token may be represented by a sequence of bytes which are used to represent immutable data. The size of the immutable data may be larger, smaller, or the same size as the token.

With a token, the requestor 210 may request that all or portions of the data represented by the token be logically written. Sometimes herein this operation is called an offload write. The requestor 210 may do this by sending the token together with one or more offsets and lengths to the data access components 215.

The data access components 215 may be implemented as a storage stack where each layer of the stack may perform a different function. Some examples of different functions include:

1. A partitioning data access component may adjust the offset of the offload read or write request before forwarding the request to the next lower data access component.

2. A RAID data access component may split the offload read or write request and forward the pieces to the same or different data access components. In the case of RAID-0, a received request may be split along the stripe boundary (resulting in a shorter effective length) whereas in the case of RAID-1, the entire request may be forwarded to more than one data access components (resulting in multiple tokens for the same data).

3. A caching data access component may write out parts of its cache that include the data that is about to be obtained by the offload read request.

4. A caching data access component may invalidate those parts of its cache that include the data that is about to be overwritten by an offload write request.

5. A data verification data access component may invalidate any cached checksums of the data that are about to be overwritten by the offload write request.

6. An encryption data access component may fail an offload read or write request.

7. A snapshot data access component may copy the data in the location that is about to overwritten by the offload write request. This may be done, in part, so that the user can later ‘go back’ to a ‘previous version’ of that data if necessary. The snapshot data access component may itself use offload read and write commands to copy the data in the location (that is about to be overwritten) to a backup location.

The examples above are not intended to be all-inclusive or exhaustive. Based on the teachings herein, those skilled in the art may recognize other scenarios in which the teachings herein may be applied without departing from the spirit or scope of aspects of the subject matter described herein.

One or more layers of the stack may be associated with a token provider. A token provider may include one or more components that may generate or obtain tokens that represent the data of the store 220 and provide these tokens to an authorized requestor

For a portion of an offload write, for the token involved, a token-relative offset may be indicated as well as a destination-relative offset. Either or both offsets may be implicit or explicit. A token-relative offset may represent a number of bytes (or other units) from the beginning of data represented by the token, for example. A destination-relative offset may represent the number of bytes (or other units) from the beginning of data on the destination. A length may indicate a number of bytes (or other units) starting at the offset.

If a data access component 215 fails an offload read or write, an error code may be returned that allows another data access component or the requestor to attempt another mechanism for reading or writing the data.

### Zero and Non-Zero Tokens

In one embodiment, a normal token (also referred to as a non-zero token) is a token that was obtained via a successful offload read and that represents immutable data. A normal token comprises an unpredictable number. The difficulty of guessing the number may be selected by the size of the number as well as the mechanism used to generate the number. As described previously, the number represents data of the store 220 but may be much smaller than the data. For example, a requestor may request a token for a 100 Gigabyte file. In response, the requestor may receive, for example, a 512 byte or other sized token.

A zero token, on the other hand, represents an arbitrary number of zeroes. A zero token may be represented as a predefined value. In one embodiment, the zero token may be represented by zero value. In another embodiment, the zero token may be represented by one or more bits where at least one of the bits is not zero. The zero token may be the same size as a normal token and may be used, as appropriate, wherever a normal token may be used.

For normal tokens, a token may not be valid unless the token was obtained via a successful offload read. Furthermore, a normal token may be invalidated for any of a number of reasons.

A storage abstraction may consider the zero token valid regardless of whether any corresponding offload read returned the zero token previously. Furthermore, a successful write of the zero token does not imply that any other client was reading or writing zeroes. In addition, the zero token value does not contain unpredictable bits. The zero token can be a single token value or a set of values and the value of the zero token need not be treated as a secret. This allows use of the zero token in an offload write without any prior offload read and for general zeroing purposes (not just copying purposes). For example, a zeroing purpose may include zeroing one or more portions of a file for initializing, resetting, or any other purpose.

A storage abstraction may respond to an offload read request with the zero token when appropriate. For example, a storage abstraction may respond with a zero token when the storage abstraction determines that the starting portion of the offload read request refers to a portion of the source storage which is zero. No tracking of the zero token is needed (as is generally needed for a normal token), since the zero token is not subject to invalidation.

When any of the data access components 215 determines that a portion of a write involves one or more zeroes, the component may convert the portion to an offload write of the zero token, even if the zero token was not obtained in a previous offload read.

When a data access component receives an offload read request and determines that a referenced portion of the storage abstraction starts with zeroes, the data access component may provide the zero token in the response to the offload read request. For protocols in which partial servicing of an offload read is allowed, a data access component may also provide an indication of what portion of the offload read request was serviced.

A storage abstraction may or may not be capable of providing normal tokens. In either case, the storage abstraction may return the zero token to service an offload read that involves a portion of the storage abstraction that is zero. In addition, there may or may not be a normal token provider at a layer lower than the storage abstraction.

A zero token may be returned to represent portions of a storage abstraction that are not currently backed by physical storage but that are allowed to be read as zero. This may include ranges defined in a thin-provisioned fashion as zero, unmapped, or the like, as long as access mechanisms allow for a normal read from the portion of the storage abstraction to read all zeroes. This subtle distinction between “zero” and “allowed to read as zero” may be relevant to a portion of a storage container that is trimmed, unmapped, or the like.

When a storage abstraction receives an offload write request, the storage abstraction may check to see if the provided token is a valid token. In one implementation, for a zero token, this check for token validity treats the zero token as a valid token. In another implementation, once it is determined that the provided token is the zero token, no additional checks regarding the token may be performed. If the storage abstraction detects that an offload write request specifies the zero token, the storage abstraction may logically write zeroes to the portion of the storage abstraction specified by the offload write request (or a sub-portion thereof). This logical write of zeroes may be achieved via any means available to the storage abstraction to logically write zeroes.

As mentioned previously, in contrast with normal tokens, a storage abstraction and/or token provider may not require that an offload read is performed to “create” the zero token. Instead, the zero token “exists” without having been created by any offload read. Also in contrast with normal tokens, the storage abstraction and/or token manager may not be allowed to invalidate the zero token.

A storage abstraction may perform data structure updates in its own layer to logically write at least a portion of the zeroes of an offload write. These data structure updates are not writes of bulk zeroes but rather a modification of internal data structures of the storage abstraction. For example, a storage abstraction may include a logical disk based on a virtual hard drive (VHD) file. As another example, a storage abstraction may include a logical disk implemented as part of a storage array. As yet another example, a storage abstraction may include a file or a sparse file. Many of these storage abstractions have mapping data structures that map from storage abstraction virtual address (LBA, file offset, or the like) to physical locations where the data is stored in a “lower” layer. Some storage abstractions may also be thin provisioned, in that not all of the virtual address range of the storage container is backed by physical storage locations.

When an offload write of the zero token is directed at a portion of a storage abstraction that is not currently backed by physical storage, the storage abstraction may avoid allocating any additional storage locations to hold zeroes. Instead, the storage abstraction may change data structures to ensure that the portion of the storage abstraction is defined to read as zero. For example, this may involve changing mapping information to cause this to be true if needed. After changing the data structures as appropriate, the storage abstraction may then indicate that the off load write has succeeded and has written at least a portion of the requested target portion specified in the offload write.

When an offload write of the zero token is directed at a portion of the storage container that is currently backed by physical storage, the storage container may de-allocate the physical storage (i.e., free it up for storing other data), and modify the mapping from virtual address (LBA or offset; so that the relevant portion of the destination storage abstraction is defined to be zero without needing any physical storage to store those zeroes. The storage abstraction may use this method on a sub-portion of the portion of the destination storage container identified in the offload write command.

A storage abstraction may service an offload write of the zero token at least in part by performing a normal write of zeroes to the layer responsible for storing data backing a portion of the storage abstraction. To do this, the normal write of zero may be directed at the next layer closer to physical storage. For example, a storage abstraction that implements logical disks that store data within VHD files may direct a normal write of zeroes to a VHD file, or in other words, to a file system responsible for implementing the VHD file. A storage abstraction that implements files (e.g., a file system) may direct a normal write of zero to a logical disk. A storage abstraction that implements a logical disk based on physical disks may direct the normal write of zero to the physical disks.

A storage abstraction may service an offload write of the zero token by sending an offload write of the zero token to the layer responsible for storing data backing a portion of the storage container. Most examples applicable to a normal write of zero are applicable to an offload write of zero also, except that the layer responsible for storing data backing a portion of the storage abstraction may be required to support offload write of the zero token. One strategy that may be employed by a requestor seeking to write zeroes is to first attempt an offload write of the zero token, and then if that fails, a normal write of zeroes. The storage abstraction may accept any truncation performed by the target layer and propagate that truncation back to the requestor of the original offload write of the zero token, or may issue another zeroing command to pick up where the truncation left off.

A storage abstraction may service an offload write of the zero token by sending a different command that writes zeroes directed at the layer responsible for storing data backing a portion of the storage abstraction. To ensure timely completion, the storage abstraction may truncate the offload write of a zero request to a length which allows for completion of the offload write of zero token to occur in a reasonable period of time. One exemplary command that the storage abstraction may send to the layer is the SCSI WRITE SAME command, specifying zero as the data to write.

A storage abstraction may attempt to limit the time spent in servicing an offload write even if the storage abstraction is issuing multiple commands to a layer below in order to service the offload write of the zero token. Limiting the duration of the original offload write of zero token command may be achieved by the storage abstraction by limiting the number and length of zeroing commands issued to a layer below and checking the elapsed time against a threshold before issuing more zeroing commands. This limiting may also be achieved in some cases by cancelling already-issued zeroing commands, when supported by the layer below.

Furthermore, the zeroing commands to the layer below may be limited in size so that no single zeroing command sent to the layer below will take too long and so that the total elapsed time to service the original offload write of the zero token will not exceed a threshold. Limiting the size of the zeroing commands sent down to a lower layer may be more strictly enforced when the downward commands have no way to self-truncate. Strict enforcement may also be enforced even when the command sent down to storage stack does have the ability to truncate (e.g. as when the command sent down is itself an offload write of the zero token).

FIG. 3 is a block diagram that generally represents another exemplary arrangement of components of systems that operates in accordance with aspects of the subject matter described herein. As illustrated in FIG. 3, the arrangement includes a requestor 305, a source storage abstraction 310, a destination storage abstraction 311, a source physical store 315, a destination physical store 316, and may include other components (not shown).

The requestor 305 may operate in a similar manner as the requestor 210 of FIG. 2. The source storage abstraction 310 and the destination storage abstraction 311 may abstract the storage of the source physical store 315 and the destination physical store 316 as a file, volume, disk, virtual disk, logical unit, data stream, alternate data stream, metadata stream, or the like.

In one embodiment, there may be multiple source storage abstractions between the requestor 305 and the source physical store 31 with a source storage abstraction higher in the stack relying on a storage abstraction provided by a source storage abstraction lower in the stack. Likewise, there may be multiple destination storage abstractions between the requestor 305 and the destination physical store 316.

One or more of the data access components of FIG. 2 may reside on the requestor 305, the storage abstractions 310-311, and the physical stores 315-316. In addition, a token manager may also reside internally, externally, or have components both internally and externally to one or more of the components indicated above.

In one embodiment, the source physical store and the destination physical store may be the same physical store. In another embodiment, they may be separate physical stores that may communicate with each other to obtain data related to offload reads and writes.

In operation, the requestor 305 may be operable to send a zero token or potentially a non-zero token with an offload write request to the destination storage abstraction 311. For a zero token, the destination storage abstraction may be operable to receive the token and to logically write at least one zero corresponding to the offload write request to a destination indicated by the offload write request.

The requestor 305 may obtain the zero token in response to an offload read request to the source storage abstraction 310 or may simply seek to use the zero token to write zeroes without first obtaining the zero token in response to an offload read request. In other words, if the requestor 305 wants to write zeroes to the destination storage abstraction 311, the requestor 305 may send the zero token with an offload write request to write zeroes to the destination storage abstraction 311 regardless of whether the requestor first obtained the zero token in an offload read request.

In response to receiving a zero token, the destination storage abstraction 311 may refrain from checking whether an off load read request was previously used to obtain the zero token. This is in contrast to receiving a non-zero token, in which the destination storage abstraction 311 may check that the non-zero token was received from a successful offload read request and is still valid.

To logically write at least one zero, the destination storage abstraction 311 may update a data structure. Updating the data structure may indicate that a portion of the destination storage abstraction logically includes zeroes even if physical zeroes have not been written to the portion as mentioned previously. Updating the data structure may be performed without allocating additional physical storage to hold zeroes corresponding to the offload write request.

As also described previously, when writing zeroes to the destination storage abstraction would cause a portion of the destination storage to logically have zeroes, the destination storage abstraction 311 may update a data structure to free a portion of physical storage (e.g., the destination physical store 316) backing the destination storage abstraction. In updating the data structure, the destination storage abstraction 311 logically zeroes the portion.

The destination storage abstraction 311 may logically write zeroes in response to the offload write request by writing one or more physical zeroes to a component in a layer below the destination storage abstraction 311. For example, if another storage abstraction (not shown) is between the destination storage abstraction 311 and the destination physical store 316, the destination storage abstraction 311 may logically write zeroes by writing physical zeroes to this component. As another example, the destination storage abstraction 311 may write zeroes directly to the destination physical store 316.

The destination storage abstraction 311 may logically write zeroes by converting the offload write request into a command that writes zeroes and sending the command to a component that implements the command. For example, the destination storage abstraction 311 may logically write zeroes by sending a SCSI WRITE SAME command to a component in a layer below the destination storage abstraction 311. The SCSI WRITE SAME command may then physically write zeroes to a destination.

The destination storage abstraction 311 may truncate an offload write request by returning data to the requestor 305 that indicates a number of zeroes that were logically written.

The destination storage abstraction may be capable of processing offload write requests with the zero token even if the destination storage abstraction 311 does not have the capability to use a non-zero token with the offload write request.

The source storage abstraction 310 may provide the zero token in response to receiving an offload read request from the requestor. In doing so, the source storage abstraction 310 may be operable to determine that the offload read request is directed to a portion of the source storage abstraction 310 that logically includes zeroes at a range associated with the offload read request.

As indicated previously, in some implementations, a component servicing an offload read or an offload write request may indicate that the component was able to service only a portion of the request. Along these lines, the source storage abstraction 310 may provide an indication of a length of the offload read request that is serviced by the zero token.

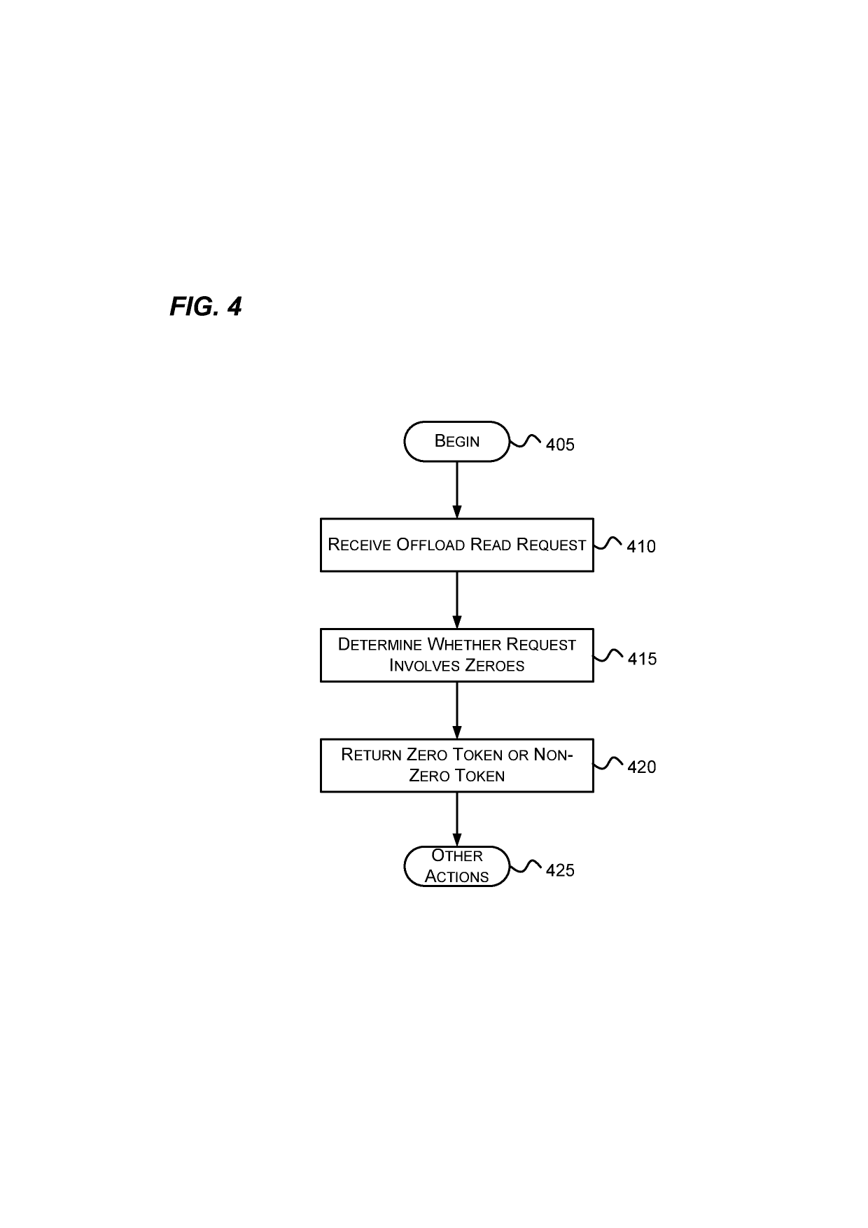

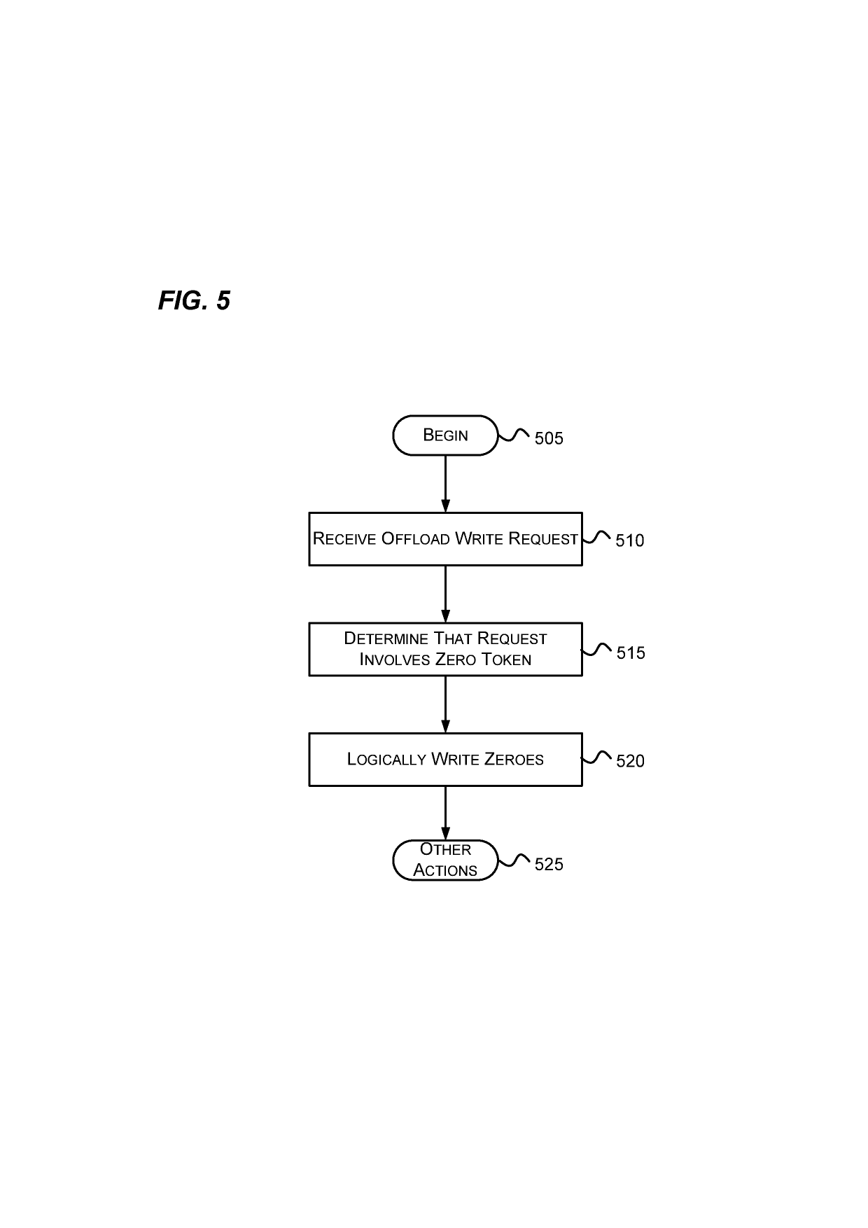

FIGS. 4-5 are flow diagrams that generally represent exemplary actions that may occur in accordance with aspects of the subject matter described herein. For simplicity of explanation, the methodology described in conjunction with FIGS. 4-5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 4 is a flow diagram that generally represents exemplary actions that may occur in conjunction with an offload read request in accordance with aspects of the subject matter described herein. At block 405, the actions begin.

At block 410, an offload read request is received. The offload read request is received with a length. The length indicates how many bytes or other units are desired to be read by the offload read. For example, referring to FIG. 3, the source storage abstraction 310 receives an offload read request from the requestor 305

At block 415, a determination is made as to whether the request is to be fulfilled with a zero token. This may involve determining whether the start location requested by the read request logically includes a zero. For example, as mentioned previously, determining whether the start location logically includes zeroes may include examining a data structure that indicates that a range requested by the offload read request is not backed by physical storage and that the range is allowed to be read as zero.

If the start location of the read request logically includes a zero (and there are enough zeroes to justify a zero token), a zero token may be returned. Having enough zeroes to justify a zero token may be fixed at a certain number of zeroes or configurable depending on implementation. For example, referring to FIG. 3, the source storage abstraction 310 may determine whether the start of a range associated with the offload read request logically includes zeroes.

At block 420, a zero or non-zero token is returned based on the determination above. For example, the source storage abstraction 310 may return a zero or non-zero token in response to an offload read request from the requestor 305. In responding to the offload read request, a length that is serviced by the token may be returned. This length may be equal to or less than the length requested in the offload read request.

In one example, the first response to an offload read request may return a non-zero token with an indication that not all the offload read request was serviced by non-zero token. In response, the requestor 305 may send another offload read request. In response to this second offload read request, the source storage abstraction 310 may return a zero token and another length indicating how much of the second offload read request is serviced by the zero token.

At block 425, other actions, if any, may be performed.

FIG. 5 is a flow diagram that generally represents exemplary actions that may occur in conjunction with an offload write request in accordance with aspects of the subject matter described herein. At block 505, the actions begin.

At block 510, an offload write request is received. For example, referring to FIG. 3, the destination storage abstraction 311 may receive an offload write request and a token from the requestor.

At block 515, a determination is made that the request involves the zero token. This may be done, for example, by comparing the token received to a predefined value that represents the zero token. For example, referring to FIG. 3, the destination storage abstraction 311 may compare the received token with a value representing the zero token. The term “value” is to be construed as a sequence of one or more bits.

If the destination storage abstraction determines that the offload write request involves the zero token, the destination storage abstraction may refrain from verifying whether an offload read request was used to obtain the zero token.

At block 520, zeroes are logically written to a destination indicated by the offload write. For example, referring to FIG. 3, the destination storage abstraction 311 may logically write zeroes to a destination indicated by an offload write request received by the destination storage abstraction 311.

As mentioned previously, logically writing zeroes to a destination indicated by the offload write may include updating a data structure. For example, if the offload write request is directed at a portion of a storage abstraction that is currently not backed by physical storage, the data structure may be updated to indicate that the portion logically includes zeroes. Doing this may also avoid allocating additional physical storage to hold zeroes corresponding to the offload write request.

As another example, updating a data structure may include freeing a portion of the physical storage as the portion would be logically zeroed by the offload write request.

As another example, logically writing zeroes may include sending a non-offload write request to write one or more zeroes to another component.

As another example, logically writing zeroes may include sending another offload write request of the zero token to a component responsible for storing data that backs a portion of the storage abstraction.

As another example, logically writing zeroes may include converting the offload write request into a different command that writes zeroes and sending the different command to a component that implements the command.

The examples above are not intended to be all-inclusive or exhaustive of the ways that may be used to logically write zeroes. Based on the teachings herein, those skilled in the art may recognize other ways to logically write zeroes in response to an offload write request that are within the spirit and scope of aspects of the subject matter described herein.

The teachings described herein with respect to the zero token may also be applied to tokens that represent other constant values without departing from the spirit or scope of aspects of the subject matter described herein. For example, a token may represent ones, twos, or some other constant value including a constant having a repeating pattern of digits of some length. Such a token may be used just like a zero token except that an offload write involving the token may cause the constant value of the token to be written.

As can be seen from the foregoing detailed description, aspects have been described related to a zero token. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

1. In a computing environment, a system, comprising:
a destination storage abstraction operable to receive a zero token in conjunction with an offload write request, the request originating from a requestor that is operable to send the zero token, the zero token representing one or more zeroes, and, in response to receiving the zero token, to logically write at least one zero corresponding to the offload write request to a destination indicated by the offload write request.

2. The system of claim 1, wherein the destination storage abstraction is further operable to refrain from checking whether an offload read request was previously used to obtain the zero token.

3. The system of claim 1, wherein the destination storage abstraction is operable to logically write at least one zero corresponding to the offload write request to a destination indicated by the offload write request by being operable to update a data structure, updating the data structure indicating that a portion of the destination storage abstraction logically includes zeroes, the updating the data structure performed without allocating additional physical storage to hold zeroes corresponding to the offload write request.

4. The system of claim 1, wherein the destination storage abstraction is operable to logically write at least one zero corresponding to the offload write request to a destination indicated by the offload write request by being operable to update a data structure to free a portion of physical storage backing the destination storage abstraction, the data structure as updated logically zeroing the portion.

5. The system of claim 1, wherein the destination storage abstraction is operable to logically write at least one zero corresponding to the offload write request to a destination indicated by the offload write request by being operable to write one or more physical zeroes to a component in a layer below the destination storage abstraction.

6. The system of claim 1, wherein the destination storage abstraction is operable to logically write at least one zero corresponding to the offload write request to a destination indicated by the offload write request by being operable to convert the offload write request into a command that writes zeroes and sending the command to a component that implements the command.

7. The system of claim 1, wherein the destination storage abstraction is further operable to indicate a number of zeroes that were logically written by the destination storage abstraction in response to the offload write request, the number potentially being less than a number of zeroes the offload write request indicated to write.

8. The system of claim 1, further comprising a source storage abstraction capable to provide the zero token in response to receiving an offload read request from the requestor, the source storage abstraction operable to determine that the offload read request is directed to a portion of the source storage abstraction that logically includes zeroes.

9. The system of claim 8, wherein the source storage abstraction is further operable to provide an indication of a length of the offload read request that is serviced by the zero token.

10. A method implemented at least in part by a computer, the method comprising:
receiving an offload read request and an indication of a first length associated with the offload read request;
determining that the offload read request is directed at a storage abstraction that logically includes zeroes at a start of a range associated with the offload read request; and
responding to the offload read request with a zero token and an indication of a second length that is serviced by the zero token, the second length potentially equal to or less than the first length, the zero token representing one or more zeroes, the zero token a predefined value.

11. The method of claim 10, further comprising, responding to the offload read request with a non-zero token, and indicating that the non-zero token is associated with a third length that is less than the first length, the non-zero token representing a first portion of data of a storage abstraction, the first portion before a second portion that includes zeroes.

12. The method of claim 10, wherein determining that the offload read request is directed at a storage abstraction that logically includes zeroes at a range associated with the offload read request comprises examining a data structure that indicates that the range is not backed by physical storage and that the range is allowed to be read as zero.

13. A method implemented at least in part by a computer, the method comprising:
receiving an offload write request and a first token, the first token potentially being a non-zero token or a zero token;
determining that the first token is a zero token by comparing the first token to a predefined value that represents the zero token, the zero token representing one or more zeroes; and
logically writing at least one zero corresponding to the offload write request to a destination indicated by the offload write request.

14. The method of claim 13, further comprising refraining from verifying whether an offload read request was used to obtain the zero token.

15. The method of claim 13, wherein logically writing at least one zero corresponding to the offload write request to a destination indicated by the offload write comprises updating a data structure.

16. The method of claim 15, further comprising checking whether a portion of the offload write request is directed at a portion of a storage abstraction that is currently not backed by physical storage and wherein updating the data structure indicates that the portion logically includes zeroes, the updating the data structure avoiding allocating additional physical storage to hold zeroes corresponding to the offload write request.

17. The method of claim 15, wherein updating the data structure comprises freeing a portion of the physical storage for use in storing other data, the portion logically zeroed after the offload write request completes.

18. The method of claim 13, wherein logically writing at least one zero corresponding to the offload write request to a destination indicated by the offload write request comprises sending a non-offload write request to write one or more zeroes to another component.

19. The method of claim 13, wherein logically writing at least one zero corresponding to the offload write request to a destination indicated by the offload write request comprises sending another offload write request of the zero token to a component responsible for storing data that backs a portion of the storage abstraction.

20. The method of claim 13, wherein logically writing at least one zero corresponding to the offload write request to a destination indicated by the offload write request comprises converting the offload write request into a different command that writes zeroes and sending the different command to a component that implements the command.
